(19) United States
(12) Patent Application Publication
(10) Pub. No.: US 2018/0010674 A1
(43) Pub. Date: Jan. 11, 2018

(54) TORQUE POSITION-LIMITING DEVICE

(71) Applicant: Chin-Hsing HORNG, Taoyuan City (TW)

(72) Inventor: Chin-Hsing HORNG, Taoyuan City (TW)

(21) Appl. No.: 15/206,292

(22) Filed: Jul. 10, 2016

(51) Int. Cl. F16H 35/00; F16H 19/04

(52) U.S. Cl. CPC F16H 35/00; F16H 19/04; F16H 2035/006; F16H 2019/046

(57) ABSTRACT

A torque position-limiting device includes a pivot member affixed to an external substrate, two compressible arms respectively extended from two opposite ends thereof toward each other with a gap defined therebetween and a smoothly curved bearing surface located on an outer side of each elastically compressible arm, and a position-limiting member including a circular pivot hole pivotally coupled to the pivot member, an abutment surface located on an inner perimeter thereof and abutted against each smoothly curved bearing surface of the pivot member and an outer ring gear portion located on an opposing outer perimeter thereof and drivable by an external force to turn the position-limiting member about the pivot member and to further cause generation of a friction force between each smoothly curved bearing surface of the pivot member and the abutment surface of the position-limiting member.

### BACKGROUND OF THE INVENTION

1. Field of the Invention

The present invention relates to hinge technology and more particularly, to a torque position-limiting device, which comprises a pivot member affixed to a substrate, and a position-limiting member pivotally coupled to the pivot member and rotatable by an external force to cause generation of a friction force between the position-limiting member and the pivot member for stepless positioning when the external force disappears.

2. Description of the Related Art

In order to make a mobile electronic device more portable for convenient use, the prior art is to house the control unit in the housing of the mobile electronic device to reduce the dimension of the mobile electronic device, or to install the screen or keyboard in a slidable manner through the transmission of a gear and rack mechanism. In this design, a latch-based or bump interference-based positioning means is needed for holding the screen or keyboard in position. However, a latch-based or bump interference-based positioning means has the drawbacks of complicated structure and manufacturing process, operation inconvenience, making the mobile electronic device unable to be in line with the concept of light, thin, short and small mobile electronic device characteristics.

### SUMMARY OF THE INVENTION

The present invention has been accomplished under the circumstances in view. It is therefore the main object of the present invention to provide a torque position-limiting device, which has a simple structure and is practical for use in a mobile electronic device having light, thin, short and small characteristics and, which comprises a pivot member and a position-limiting member pivotally coupled to the pivot member and capable of generating a friction force between the position-limiting member and the pivot member for stepless positioning when it is rotated.

It is another object of the present invention to provide a torque position-limiting device, which generates a different amount of friction force when the position-limiting member is turned about the pivot member in the reversed direction, and thus, the torque position-limiting device can match with the torque required to open or close the mobile electronic device.

To achieve these and other objects of the present invention, a torque position-limiting device comprises a pivot member and a position-limiting member. The pivot member comprises a base portion, two elastically compressible arms respectively extended from two opposite ends of the base portion and defining with the base portion a flexible space, and a smoothly curved bearing surface located on an outer side of each elastically compressible arm. The position-limiting member comprises a body portion, a circular pivot hole defined in the body portion and pivotally coupled to the pivot member, an abutment surface located on an inner perimeter of the body portion around the circular pivot hole and abutted against the the smoothly curved bearing surface on each elastically compressible arm, and an outer ring gear portion located on an opposite outer perimeter of the body portion and drivable to turn the position-limiting member about the pivot member and to further cause generation of a friction force between each smoothly curved bearing surface of the pivot member and the abutment surface of the position-limiting member.

### BRIEF DESCRIPTION OF THE DRAWINGS

FIG. 1 is an oblique top elevational view of a torque position-limiting device in accordance with a first embodiment of the present invention.

FIG. 2 is a front view of the torque position-limiting device in accordance with the first embodiment of the present invention.

FIG. 3 is an exploded view of the torque position-limiting device in accordance with the first embodiment of the present invention.

FIG. 4 is a schematic applied view of the first embodiment of the present invention, illustrating the torque position-limiting device installed in a smartwatch.

FIG. 5 is a sectional top view of FIG. 4.

FIG. 6 is an oblique top elevational view of a torque position-limiting device in accordance with a second embodiment of the present invention.

FIG. 7 is a front view of the torque position-limiting device in accordance with the second embodiment of the present invention.

FIG. 8 is an exploded view of the torque position-limiting device in accordance with the second embodiment of the present invention.

FIG. 9 is a schematic sectional applied view of the second embodiment of the present invention, illustrating the torque position-limiting device installed in a smartwatch.

FIG. 10 is an enlarged view of Part A of FIG. 9.

### DETAILED DESCRIPTION OF THE PREFERRED EMBODIMENT

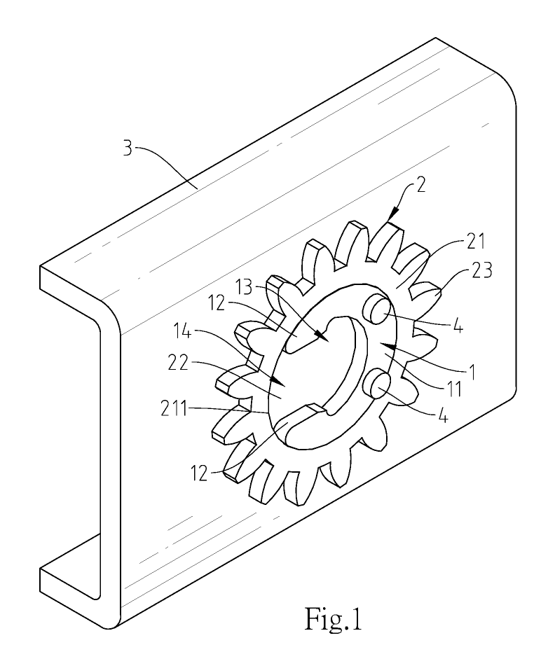

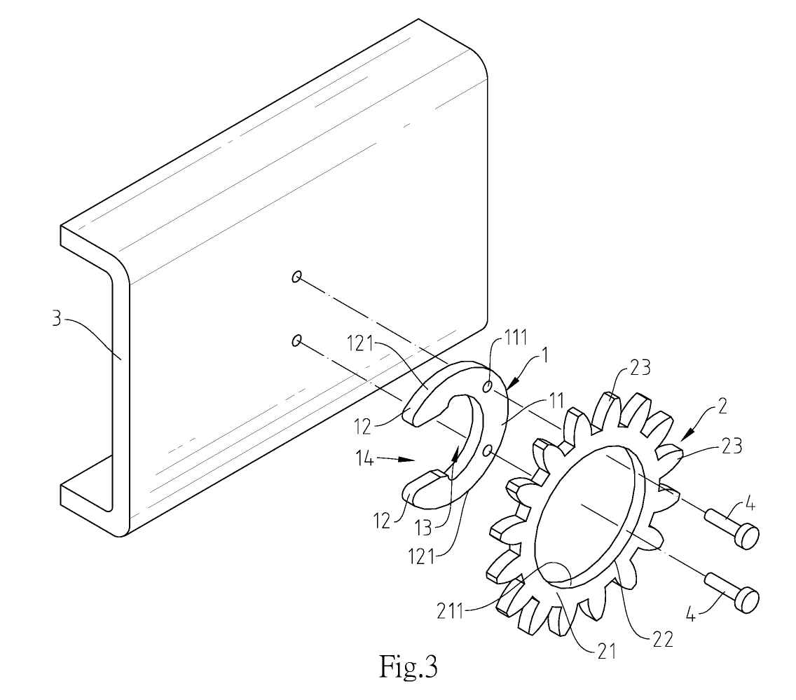

Referring to FIGS. 1-3, a torque position-limiting device in accordance with a first embodiment of the present invention is shown. The torque position-limiting device comprises a pivot member 1 and a position-limiting member 2.

The pivot member 1 comprises a base portion 11, a plurality of mounting holes 111 cut through opposing front and back surfaces of the base portion 11, two elastically compressible arms 12 respectively extended from two distal ends of the base portion 11 to face toward each other, a flexible space 13 surrounded by the elastically compressible arms 12 and the base portion 11, a smoothly curved bearing surface 121 located on an outer side of each of the two elastically compressible arms 12 opposite to the flexible space 13, and a gap 14 defined between the two elastically compressible arms 12 in communication with the flexible space 13.

The position-limiting member 2 comprises a body portion 21, a circular pivot hole 22 defined in the body portion 21, an abutment surface 211 located on an inner perimeter of the body portion 21 around the circular pivot hole 22, and an outer ring gear portion 23 located on an opposing outer perimeter of the body portion 21.

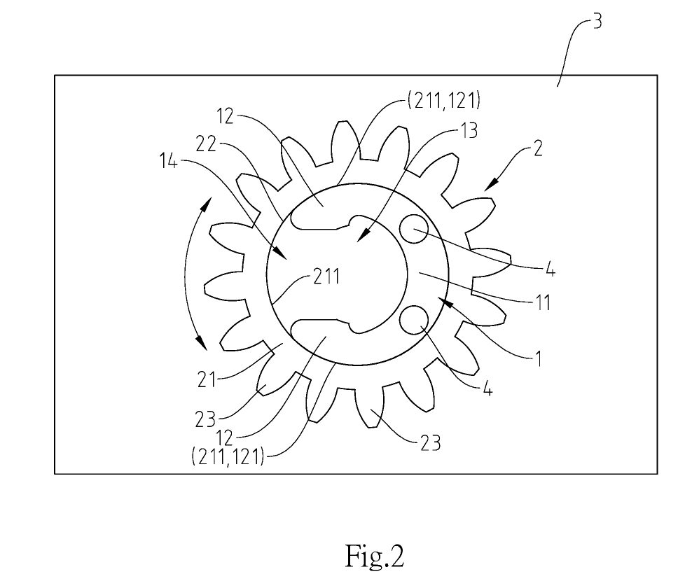

Further, the pivot member 1 is mounted on an outer surface of a substrate 3. Further, fastening members 4 are respectively mounted in the mounting holes 111 of the pivot member 1 and fastened to the substrate 3 to affix the base portion 11 of the pivot member 1 to the substrate 3. The position-limiting member 2 is pivotally connected to the pivot member 1 by coupling the circular pivot hole 22 to the pivot member 1, keeping the abutment surface 211 of the position-limiting member 2 in abutment against the smoothly curved bearing surfaces 121 of the pivot member 1 to force the elastically compressible arms 12 in direction toward the inside of the flexible space 13. Thus, the elastically compressible arms 12 are elastically compressed to store elastic potential energy for reset. The elastic restoring force generated by the elastically compressible arms 12 causes generation of a friction force between the smoothly curved bearing surfaces 121 and the abutment surface 211. Referring also to FIG. 2, when applying an external pushing force larger than the friction force between the smoothly curved bearing surfaces 121 and the abutment surface 211 to the outer ring gear portion 23 of the position-limiting member 2, the position-limiting member 2 will be forced to turn about the pivot member 1. Further, because the two elastically compressible arms 12 are respectively extended from the two distal ends of the base portion 11 to face toward each other, the pivoting direction of the position-limiting member 2 will be same as the extending direction of one elastically compressible arm 12 and reversed to the extending direction of the other elastically compressible arm 12. Thus, reversing the pivoting direction of the position-limiting member 2 does not cause any change in the friction force between the smoothly curved bearing surfaces 121 and the abutment surface 21.

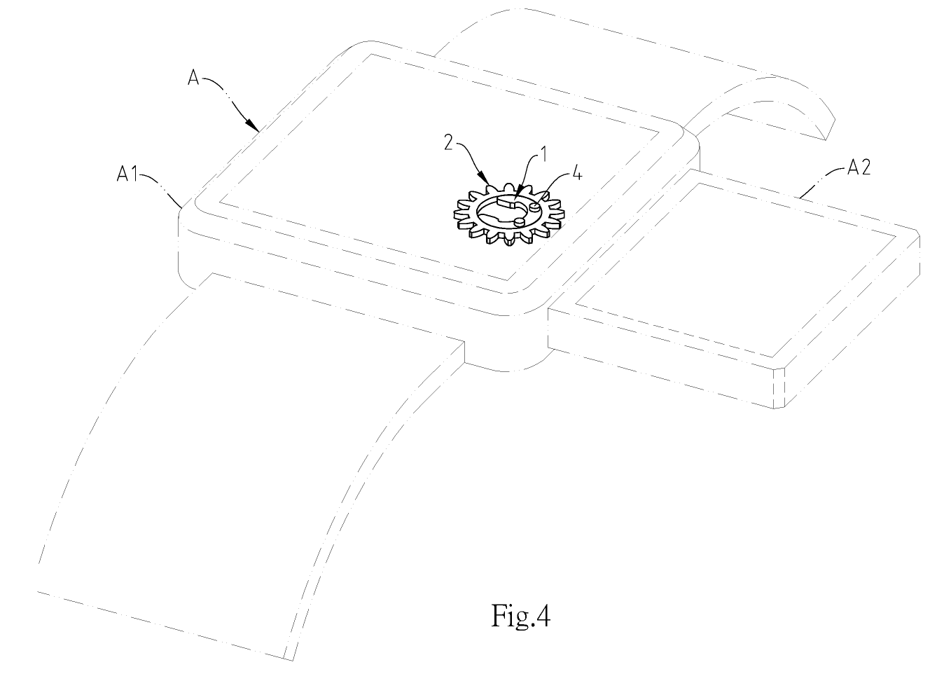

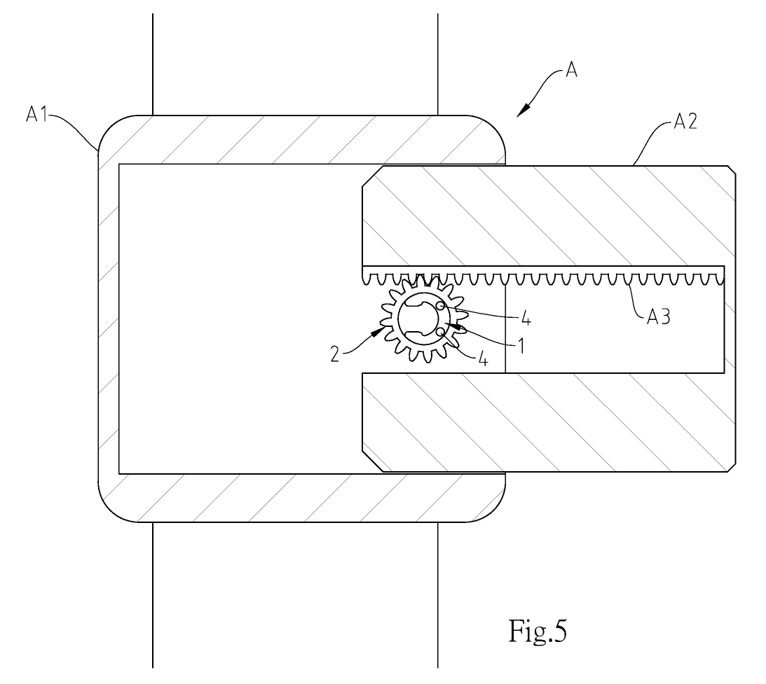

Referring to FIGS. 4 and 5 and FIG. 2 again, the torque position-limiting device in accordance with the first embodiment of the present invention can be used in a smartwatch A. As illustrated, affix the base portion 11 of the pivot member 1 to a housing A1 of the smartwatch A with fastening members 4 to keep the outer ring gear portion 23 of the position-limiting member 2 in mesh with a tooth rack A3 at a bottom side of a screen A2 in the housing A1. When the user pulls the screen A2 out of the housing A1, the tooth rack A3 will be moved with the screen A2 to turn the outer ring gear portion 23 of the position-limiting member 2 about the pivot member 1.

By means of the friction force generated between the smoothly curved bearing surface 121 of the pivot member 1 and the abutment surface 211 of the position-limiting member 2, the screen A2 is positively held in position after the user released the hand from the screen A2.

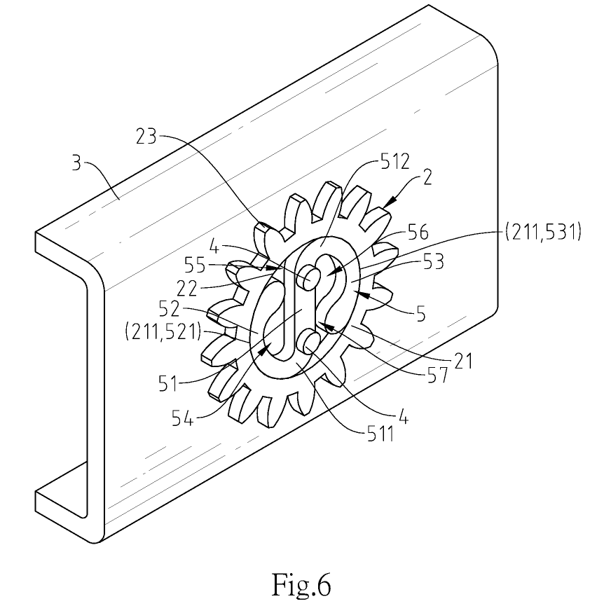

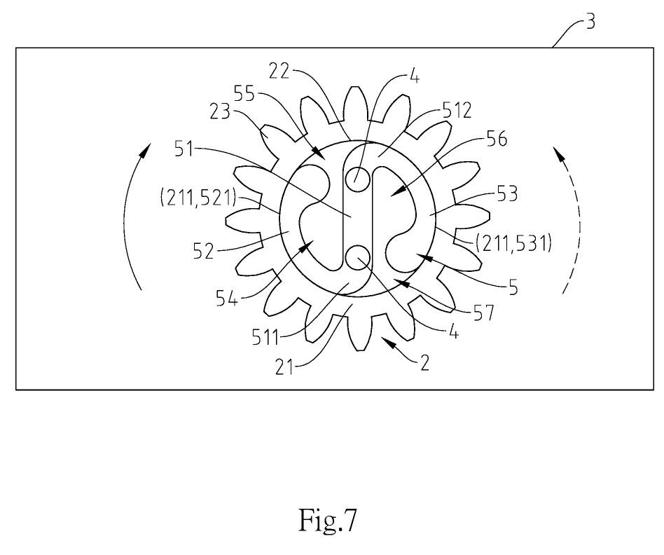

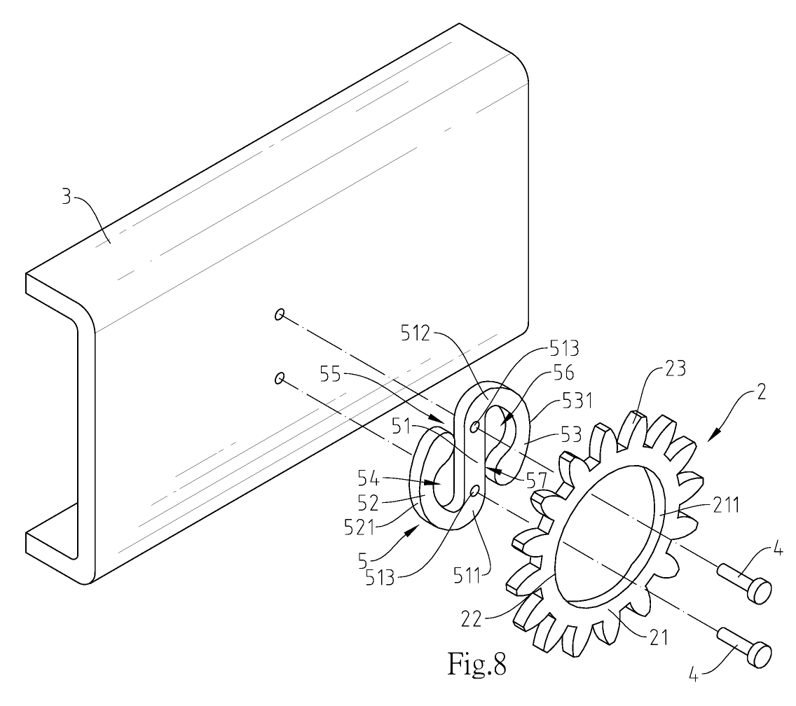

Referring to FIGS. 6-8, a torque position-limiting device in accordance with a second embodiment of the present invention is shown. This second embodiment is substantially similar to the aforesaid first embodiment with the exception the design of the pivot member 5. According to this second embodiment, the pivot member 5 comprises a base portion 51 defining a first end portion 511 and an opposing second end portion 512, a plurality of mounting holes 513 cut through opposing front and back sides of the base portion 51, a first elastically compressible arm 52 extended from the first end portion 511 of the base portion 51 toward the second end portion 512 and disposed at one lateral side relative to the base portion 51, a second elastically compressible arm 53 extended from the second end portion 512 toward the first end portion 511 and disposed at an opposite lateral side relative to the base portion 51, a first flexible space 54 surrounded by the first elastically compressible arm 52 and the base portion 51, a first smoothly curved bearing surface 521 located on the outer side of the first elastically compressible arm 52 opposite to the first flexible space 54, a first gap 55 defined between a distal end of the first elastically compressible arm 52 and the base portion 51 in communication with the first flexible space 54, a second flexible space 56 surrounded by the second elastically compressible arm 53 and the base portion 51, a second smoothly curved bearing surface 531 located on an outer side of the second elastically compressible arm 53 opposite to the second flexible space 56, and a second gap 57 defined between a distal end of the second elastically compressible arm 53 and the base portion 51. The pivot member 5 is mounted on a substrate 3.Fastening member 4 are respectively mounted in the mounting hole 513 of the pivot member 5 to affix the base portion 51 of the pivot member 5 to the substrate 3. The circular pivot hole 22 of the position-limiting member 2 is pivotally coupled to the pivot member 5 to keep the first smoothly curved bearing surface 521 and second smoothly curved bearing surface 531 of the pivot member 5 in abutment against the abutment surface 211 of the position-limiting member 2 and to force the first elastically compressible arm 52 and the second elastically compressible arm 53 in direction toward the first flexible space 54 and the second flexible space 56 respectively. Thus, the first elastically compressible arm 52 and the second elastically compressible arm 53 are elastically compressed to store elastic potential energy for reset. The elastic restoring force generated by the first elastically compressible arm 52 and the second elastically compressible arm 53 causes generation of a friction force between the first and second smoothly curved bearing surface 521;531 and the abutment surface 211. Referring also to FIG. 7, when applying an external pushing force larger than the friction force between the first and second smoothly curved bearing surface 521;531 and the abutment surface 211 to the outer ring gear portion 23 of the position-limiting member 2, the position-limiting member 2 will be forced to turn about the pivot member 5. When the position-limiting member 2 is being rotated in the direction same as the extending direction of the first elastically compressible arm 52 and second elastically compressible arm 53 of the pivot member 5 (as illustrated in the solid arrowhead), the friction force between the first and second smoothly curved bearing surface 521;531 and the abutment surface 211 is relatively reduced. On the contrary, when the position-limiting member 2 is being rotated in the direction reversed to the extending direction of the first elastically compressible arm 52 and second elastically compressible arm 53 of the pivot member 5 (as illustrated in the imaginary arrowhead), the friction force between the first and second smoothly curved bearing surface 521;531 and the abutment surface 211 is relatively increased.

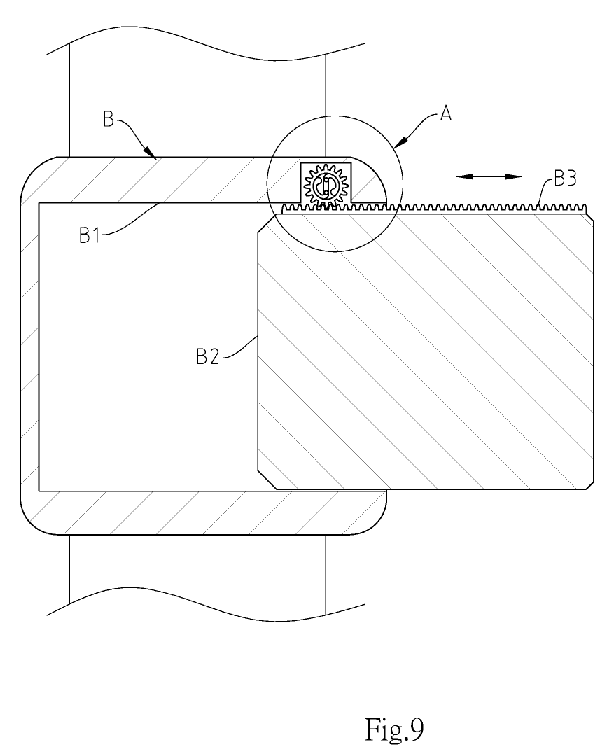

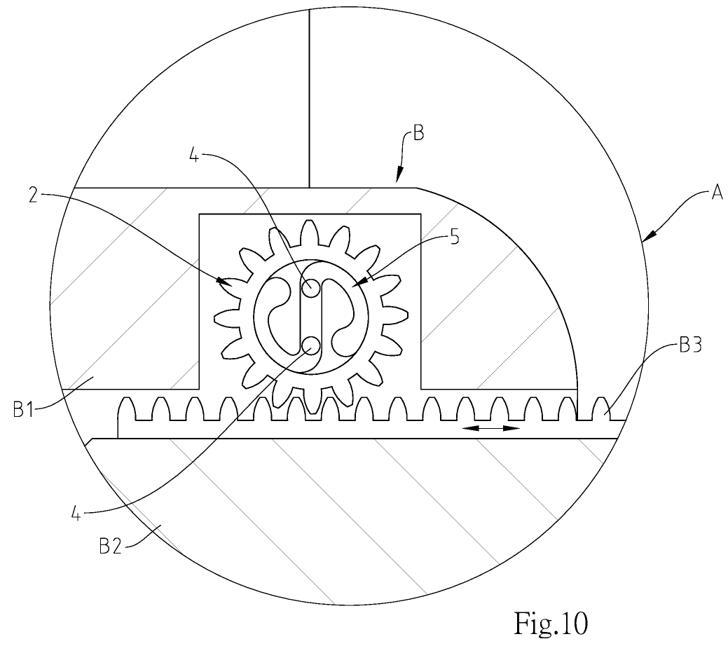

Referring to FIGS. 9 and 10 and FIG. 7 again, the torque position-limiting device in accordance with the second embodiment of the present invention can be used in a smartwatch B. As illustrated, affix the base portion 51 of the pivot member 5 to a housing B1 of the smartwatch B with fastening members 4 to keep the outer ring gear portion 23 of the position-limiting member 2 in mesh with a tooth rack B3 at one lateral side of a screen B2 in the housing B1. When the user pulls the screen B2 out of the housing B1 or pushes the screen B2 back into the inside of the housing B1, the tooth rack B3 will be moved with the screen B2 to push the outer ring gear portion 23 of the position-limiting member 2, turning the position-limiting member 2 about the pivot member 5. When the user releases the hand from the screen B2, the screen B2 is immediately held down in position by the friction force between the first and second smoothly curved bearing surface 521;531 and the abutment surface 211. Further, it requires different amounts of force to pull the screen B2 out of the housing A1 and to push it into the housing B1, facilitating the use of the smartwatch B.

What the invention claimed is:

1. A torque position-limiting device, comprising:
a pivot member comprising a base portion, at least one elastically compressible arm extended from said base portion, a flexible space surrounded by said at least one elastically compressible arm and said base portion, and a smoothly curved bearing surface located on an outer side of each said elastically compressible arm opposite to said flexible space; and
a position-limiting member comprising a body portion, a circular pivot hole defined in said body portion and pivotally coupled to said pivot member, an abutment surface located on an inner perimeter of said body portion around said circular pivot hole and abutted against said smoothly curved bearing surface of said pivot member, and an outer ring gear portion located on an opposing outer perimeter of said body portion and drivable by an external force to turn said position-limiting member about said pivot member and to further cause generation of a friction force between each said smoothly curved bearing surface of said pivot member and said abutment surface of said position-limiting member.

2. The torque position-limiting device as claimed in claim 1, wherein said pivot member further comprises a plurality of mounting holes cut through opposing front and back sides of said base portion and affixed to a substrate with respective fastening members that are respectively mounted in said mounting holes.

3. The torque position-limiting device as claimed in claim 1, wherein said said pivot member comprises two said elastically compressible arms respectively extended from two opposite ends of said base portion to face toward each other with a gap defined therebetween.

4. A torque position-limiting device, comprising:
a pivot member comprising a base portion defining a first end portion and an opposing second end portion, a first elastically compressible arm extended from said first end portion toward said second end portion and disposed at one lateral side relative to said base portion, a second elastically compressible arm extended from said second end portion toward said first end portion and disposed at an opposite lateral side relative to said base portion, a first flexible space surrounded by said first elastically compressible arm and said base portion, a first smoothly curved bearing surface located on an outer side of said first elastically compressible arm opposite to said first flexible space, a first gap defined between a distal end of said first elastically compressible arm and said base portion in communication with said first flexible space, a second flexible space surrounded by said second elastically compressible arm and said base portion, a second smoothly curved bearing surface located on an outer side of said second elastically compressible arm opposite to said second flexible space, and a second gap defined between a distal end of said second elastically compressible arm and said base portion; and
a position-limiting member comprising a body portion, circular pivot hole defined in said body portion and pivoally coupled to said pivot member, an abutment surface located on an inner perimeter of said body portion around said circular pivot hole and abutted against said first smoothly curved bearing surface of said first elastically compressible arm and said second smoothly curved bearing surface of said second elastically compressible arm, and an outer ring gear portion located on an opposing outer perimeter of said body portion drivable by an external force to turn said position-limiting member about said pivot member and to further cause generation of a friction force between said first smoothly curved bearing surface and said second smoothly curved bearing surface of said pivot member and said abutment surface of said position-limiting member.

5. The torque position-limiting device as claimed in claim 1, wherein said pivot member further comprises a plurality of mounting holes cut through opposing front and back sides of said base portion, and a plurality of fastening members respectively mounted in said mounting holes to affix said base portion to an external substrate.
